(19) United States
(12) Patent Application Publication
(10) Pub. No.: US 2004/0076219 A1
(43) Pub. Date: Apr. 22, 2004

(54) Athletic mouthguard with temperature indicating device

(75) Inventors: Mark R. Madison, Eden Prairie, MN (US); Stephen R. Fyten, Anoka, MN (US)

Correspondence Address: Timothy A. Czaja, Dicke, Billig & Czaja, P.A., 701 Building, Suite 1250, 701 Fourth Avenue South, Minneapolis, MN, 55415, US

(73) Assignee: Mark R. Madison

(21) Appl. No.: 10/274,696

(22) Filed: Oct. 18, 2002

(51) Int. Cl. G01K 11/00

(52) U.S. Cl. 374/159

(57) ABSTRACT

An athletic mouthguard including a U-shaped mouthguard body and a temperature-sensing device. The temperature-sensitive device is maintained by the mouthguard body and includes an indicator portion adapted to visually indicate information indicative of temperature. The temperature-sensing device is positioned such that upon placement of the mouthguard body within a user's mouth, the temperature-sensing device is also within the user's mouth. In this regard, the temperature-sensing device is adapted such that functioning thereof is unaffected by jarring of the mouthguard body as the user participates in an athletic activity. In one preferred embodiment, the temperature-sensing device is a thermometric strip located along an outer wall of the mouthguard body.

### BACKGROUND OF THE INVENTION

The present invention relates to monitoring and indicating body temperature of an athlete participating in an athletic activity. More particularly, it relates to a mouthguard for use in an athletic activity, adapted to indicate an internal body temperature of the wearer.

Frequently, athletes must practice or play outdoor sports during periods of the year when the outdoor temperatures are uncomfortably hot. Physical exertion under these environmental conditions may cause the athlete's internal body temperature to rise to dangerously high temperatures. Any athlete, regardless of age or physical condition, can succumb to the effects of heat while participating in an athletic activity. In fact, several well-publicized instances of professional, college, and high school athletes suffering severe heat-related injuries have recently occurred.

Under most circumstances, an athlete can avoid heat-related complications by resting, drinking fluids, placing a cooled cloth on the athlete's skin, etc., when the athlete's body temperature reaches an unsafe level. Unfortunately, it is virtually impossible to readily know what the athlete's temperature is. That is to say, the athlete cannot know whether their temperature is approaching a dangerous level, nor can the athlete's coach, trainer, and/or parent(s) accurately estimate the athlete's body temperature by simply looking at the athlete. This is especially true while the athlete is actively participating in an athletic endeavor. Of course, a conventional, rigid thermometer could be used to determine the athlete's temperature. However, most, if not all, athletes are entirely disinclined to stop participating in a particular athletic activity to have their body temperature taken with a thermometer. Conversely, there are no known temperature-sensing devices that can be inconspicuously worn by the athlete and not impede their performance. The requirement that the temperature sensing/display device be unobtrusive cannot be underestimated. Many athletes (especially children and teenagers) will simply not use or wear something that is not customary for their particular sport.

Many of the athletic endeavors in which heat-related problems arise commonly entail the athlete/participant wearing a mouthguard. For example, athletes participating in football, soccer, lacrosse, etc., are encouraged, if not required, to wear mouthguards during actual games and practices. Even in sports where mouthguards are less common (e.g., baseball), parents often insist that their child/athlete wear a mouthguard. As such, mouthguards are well-accepted by athletes, and thus may present a heretofore unrecognized opportunity for detecting body temperature with a device that the athlete will actually wear.

Mouthguards generally are produced in one of three types. The least expensive type is a “stock” mouthguard that is molded into a generic, non-specific shape and does not necessarily conform to the user's teeth and mouth. The second type is a “boil-and-bite” mouthguard that is, prior to use, immersed in boiling water for a short period of time. Subsequently, the mouthguard is immediately placed into the user's mouth, at which time he/she bites down onto the mouthguard in order to form an impression of his/her teeth upon it. The third and most expensive option is to manufacture a custom mouthguard. This is typically carried out with the aide of a competent dental professional whereby an impression of the user's teeth is taken, from which a mold is formed to produce the custom mouthguard. While some mouthguards may include an additional strap that can be latched onto a helmet face mask, the general features of an athletic mouthguard, regardless of type, are the same, as are the intended function. Namely, athletic mouthguards protect the wearer's teeth. In this regard, during use the mouthguard is inevitably subjected to jarring forces of varying magnitude. It is highly likely that for this reason, available athletic mouthguards do not and cannot include any auxiliary features such as an electronic-based device. Similarly, other medical mouthguards incorporating highly complex, delicate circuitry used to monitor bodily functioning, such as disclosed in Semrow et al., U.S. Pat. No. 4,510,941, are simply unusable for athletic activities.

Heat stroke and other heat-induced problems arising during participation in an athletic activity continue to be of great concern. Unfortunately, a convenient, readily useable temperature-sensing device applicable to athletic activities does not exist. To this end, while mouthguards are commonly used in various sporting activities, currently available mouthguards do not include temperature-sensing or indicating capabilities. Therefore, a need exists for a device capable of visually indicating when a user's body temperature has reached an unsafe level in a form that athletes will not hesitate to wear.

### SUMMARY OF THE INVENTION

One aspect of the present invention relates to a device for sensing and displaying body temperature information of an athlete participating in an athletic activity. The device includes a generally U-shaped mouthguard body and a temperature-sensing device. The mouthguard body is sized for placement over a substantial portion of at least some of a user's teeth, and is configured to protect a user's teeth while participating in an athletic activity. The temperature-sensitive device is maintained by the mouthguard body and includes an indicator portion adapted to visually indicate information indicative of temperature. With this in mind, the temperature-sensing device is positioned such that upon placement of the mouthguard body within a user's mouth, the temperature-sensing device is also within the user's mouth. In this regard, the temperature-sensing device is adapted such that functioning thereof is unaffected by jarring of the mouthguard body as the user participates in an athletic activity. In one preferred embodiment, the temperature-sensing device is a thermometric strip located along an outer wall of the mouthguard body. In another preferred embodiment, the temperature-sensing device is adapted such that an entirety thereof is disposed within the mouthguard body.

Another aspect of the present invention relates to a method of manufacturing a mouthguard for use in an athletic activity. The method includes providing a generally U-shaped mouthguard body sized for placement over a substantial portion of at least some of a user's teeth. A temperature-sensing device is also provided that includes an indicator portion adapted to visually indicate information indicative of temperature. Finally, the temperature-sensing device is secured to the mouthguard body such that the temperature-sensing device will be positioned within the user's mouth when the mouthguard body is worn. In this regard, the temperature-sensing device is applied such that it is unaffected by jarring of the mouthguard body that will inevitably occur when worn by a user while participating in an athletic activity. In one preferred embodiment, prior to applying the temperature-sensing device, the mouthguard body is heated to an elevated temperature and then shaped in accordance with the user's teeth by placing the heated mouthguard body in the user's mouth. Once shaped, the temperature-sensing device is applied to the mouthguard body.

Yet another aspect of the present invention relates to a method of sensing and displaying temperature-related information of an athlete participating in an athletic activity. The method includes providing a mouthguard including a generally U-shaped mouthguard body and a temperature-sensing device maintained by the mouthguard body. In this regard, the temperature-sensing device includes an indicator portion adapted to visually indicate information indicative of temperature. The mouthguard is placed in a user's mouth such that the temperature-sensing device is within the user's mouth. The user then participates in an athletic activity while wearing the mouthguard. The mouthguard is removed from the user's mouth to expose the indicator portion. Finally, a determination is made as to whether a temperature of the user is above an acceptable level by viewing information provided by the now exposed indicator portion. In one preferred embodiment, the step of determining whether the user's temperature has reached an unsafe level can only be performed after removing the mouthguard from the user's mouth.

### BRIEF DESCRIPTION OF THE DRAWINGS

FIG. 1 is an isometric view of an athlete temperature sensing and displaying device in accordance with the present invention;

FIG. 2 is an isometric view of a mouthguard body portion of the device of FIG. 1;

FIG. 3A is an enlarged, side view of a temperature-sensing device component of the device of FIG. 1;

FIG. 3B is an enlarged, side view of an alternative embodiment temperature-sensing device; and

FIG. 4 is a simplified, enlarged, transverse cross-sectional view of an alternative athlete temperature sensing and displaying device in accordance with the present invention.

### DETAILED DESCRIPTION OF THE PREFERRED EMBODIMENTS

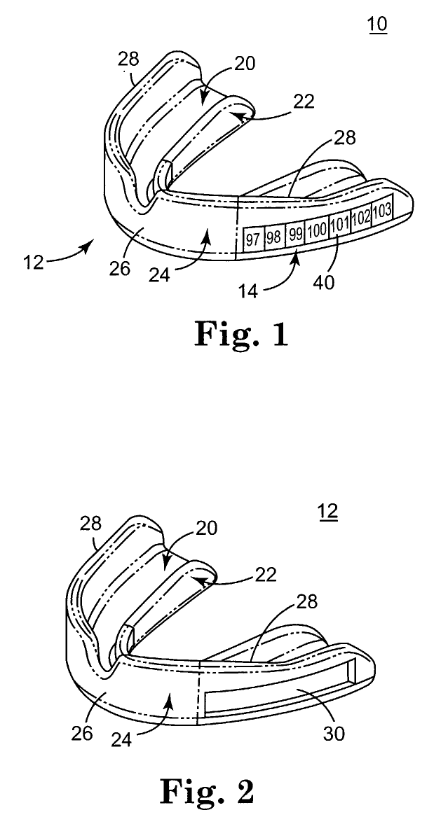

One preferred embodiment of a device 10 for sensing and displaying temperature information of an athlete (not shown) in accordance with the present invention is shown in FIG. 1. The device 10 is also referred to in this specification as a mouthguard, and includes a mouthguard body 12 and a temperature-sensing device 14. These components are described in greater detail below. In general terms, however, the temperature-sensing device 14 is maintained by the mouthguard body 12. During use, the mouthguard 10, including the temperature-sensing device 14, is placed within a user's mouth (not shown). The temperature-sensing device 14 functions to sense or detect a temperature of the user, including at times when the user is participating in an athletic activity. Periodically, the mouthguard 10 is removed from the user's mouth, with the temperature-sensing device 14 providing or displaying information indicative of the athlete's temperature to a viewer.

The mouthguard body 12 is preferably of a type known in the art. In this regard, the mouthguard body 12 can be formed from any of a number of known materials associated with available stock, “boil and bite”, or custom athletic mouthguards, and is preferably plastic. Further, the mouthguard body 12 is configured to protect teeth of the athlete when worn during an athletic activity. For example, the mouthguard body 12 is configured to cushion the athlete's teeth against blows to the athlete's mouth or face (or other parts of the body), as well as to minimize potential tooth damage when the athlete clenches his/her jaws during periods of intense physical exertion. The mouthguard body 12 can be sized for use by a child, teenager, or adult, and is useful for a wide variety of athletic activities, such as football, soccer, and field hockey, to name but a few.

The mouthguard body 12 is generally U-shaped, and is preferably sized for placement over a substantial portion of at least some of the teeth of a user's upper jaw. Alternatively, the mouthguard body 12 can be formed for placement over teeth of the lower jaw. Regardless, the mouthguard body 12 includes a base or occlusal area 20, an inner or lingual wall 22, and an outer or buccal wall 24. In conjunction with the preferred U-shape of the mouthguard body 12, the base 20 and inner and outer walls 22, 24 combine to define a central region 26 and opposing legs 28 extending therefrom.

With the above designations in mind, and with additional reference to FIG. 2, a recess 30 is preferably defined in an exterior surface 32 of the outer wall 24 along one of the opposing legs 28. As described in greater detail below, the preferred recess 30 is sized to receive the temperature-sensing device 14. Thus, the preferred recess 30 has a length, width, and depth commensurate with the temperature-sensing device 14. In the preferred location of FIG. 2, the recess 30 positions the temperature-sensing device 14 away from the central region 26 that otherwise corresponds with the front or incisor region of the user's mouth (not shown). This offset location provides an enlarged, relatively flat surface for receiving the temperature-sensing device 14, as well as positions the temperature-sensing device 14 to be in intimate contact with the user's mouth at the inside of the user's cheek. This one preferred location is less likely to be subjected to the potential cooling effects of moving air when the athlete/user breathes in and out. Alternatively, a plurality of recesses 30 can be formed (and thus, a plurality of temperature-sensing devices 14 provided), for example along both of the opposing legs 28, at the central region 26, etc. Even further, the mouthguard 10 can be configured such that the recess 30 is not required to maintain the temperature-sensing device 14 relative to the mouthguard body 12, as described in greater detail below.

The temperature-sensing device 14 is preferably a thermometric material strip that is sensitive to, or detects, one or more temperatures or change(s) in temperature, and includes an indicator portion 40 (referenced generally in FIG. 1). The indicator portion 40 is adapted to visually indicate information indicative of sensed temperature or change in temperature. Examples of preferred indicated information (including possible indicia associated with the indicator portion 40) are described below. In general terms, however, the indicator portion 40 is adapted to visually indicate or signify that the temperature-sensing device 14 has sensed a predetermined temperature or temperatures and/or that an unsafe temperature (relative to a normal human body temperature) has been sensed. The temperature sensing and displaying features of the temperature-sensing device 14 need not be precise (e.g., ±0.5° F.); in fact, the preferred temperature-sensing device 14 sacrifices precision for durability and reduced costs. In short, the temperature-sensing device 14 is primarily used to warn of unsafe body temperature, not to give an exacting temperature reading. When properly warned, the athlete can take steps to reduce body temperature. Importantly, however, the temperature-sensing device 14 is highly durable and does not rely upon sensitive components (electrical or mechanical) that, while capable of providing precise temperature readings, will undoubtedly fail in the athletic activity environment.

With the above in mind, the temperature-sensing device 14 is preferably a strip of thermometric material that indicates, by color and/or text silk-screened onto the strip, a sensed temperature or information relating to temperature. The preferred thermometric strip is a liquid crystal thermometer that incorporates general temperature-sensing materials referred to as thermochromic liquid crystals. In one preferred embodiment, the liquid crystal thermometer includes a transparent sheet of polyester (or other acceptable polymer) upon which desired indicia or characters are printed. A layer of thermochromic liquid crystals is applied (e.g., painted) to the transparent sheet. A black contrast material (e.g., black paint) is placed over the thermochromic liquid crystals, and defines a backside of the strip. The formulation of the thermochromic crystals is dependant upon the desired, predetermined temperature(s) for which identification is sought. When a temperature of the body or bodies in contact with the strip is below the active range of the liquid crystals, the crystals are transparent (so that only the black paint is seen through the transparent sheet). When a temperature of the contacting body or bodies reach the active range, the liquid crystal undergo a physical change where they become opaque and reflect light in differing colors as the temperature goes through the active range. An acceptable liquid crystal thermometer material is available from Liquid Crystal Resources of Northbrook, Ill. Alternatively, other thermographic or thermometric materials can be employed. In a preferred embodiment, the liquid crystal thermometer strip includes two opposing layers of transparent material, preferably polyester, that encase the thermochromic liquid crystals and black paint backing.

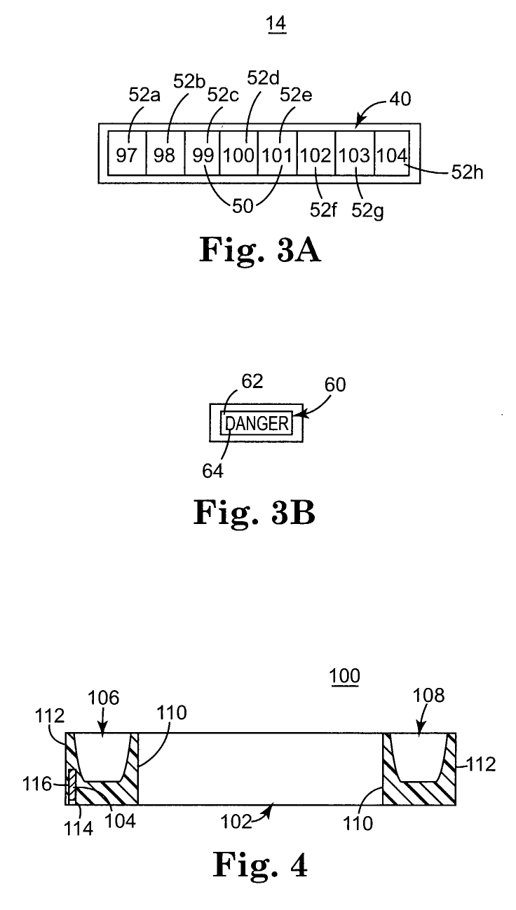

Relative to the mouthguard 10, the preferred thermometric strip is preferably shaped as a relatively small rectangle, having a width on the order of 0.25 inch and a length on the order of 1 inch. These preferred dimensions provide a sufficient size for the indicator portion 40 to display necessary information. For example, as shown in FIG. 3A, the indicator portion 40 can include a plurality of discrete zones (referenced generally at 50), with each zone including numeric indicia 52a-52h.

As a point of reference, the numeric indicia 52a-52h are shown in FIG. 3A in terms of degrees Fahrenheit; alternatively, a Celsius temperature scale can be employed. Regardless, the numeric indicia 52a-52h correspond with a temperature sensed by the temperature-sensing device 14 (e.g., the active range of the preferred thermometric liquid crystals), with the temperature-sensing device 14 being adapted to visually augment or highlight the zone 50 including the numeric indicia 52a-52h otherwise corresponding with the sensed temperature, but not augment or highlight zones 50 and related numeric indicia 52a-52h that otherwise relate to a temperature in excess of the sensed temperature. For example, relative to the one example of FIG. 3A, where the temperature-sensing device 14 senses a temperature of 100° F., the zone 50 and associated numeric indicia 52d are highlighted (e.g., brightly colored via activation of the thermochromic crystals), whereas the remaining numeric indicia 52e-52h (and corresponding zones 50) above (or greater) than the 100° F numeric indicia 52d are not highlighted (e.g., remained darkened or black in visual appearance). Notably, where the temperature-sensing device 14 utilizes thermometric liquid crystals (or similar components), one or more of the zones 50 and related numeric indicia 52a-52c below the 100° F. numeric indicia 52d may also be highlighted in a manner less prominent than the numeric indicia 52d, perhaps with a differing color. This preferred feature assures a viewer that the temperature-sensing device 14 is functioning properly when an elevated body temperature is indicated; the viewer will readily understand that the athlete's/user's temperature has progressively risen or “passed” beyond at least one of the lower temperatures. This is important in instances where an excessively high body temperature is indicated (e.g., 101° F.). Under these circumstances, were the viewer not given a visual confirmation that a temperature of 100° F. (perhaps even 99° F.) had also been sensed, he/she might mistakenly believe that this temperature-sensing device 14 had malfunctioned.

Alternatively, the temperature-sensing device 14, and in particular the indicator portion 40, can be configured to indicate temperature in a different manner. For example, FIG. 3B illustrates an alternative embodiment indicator portion 60 including a single zone 62 with indicia 64. The indicator portion 60 is adapted to visually highlight the zone 62 including the indicia 64 (e.g., change in color) when a predetermined temperature is detected by the temperature-sensing device 14. For example, the indicator portion 60 can be adapted such that the zone 62 is highlighted when the sensed temperature reaches or exceeds 100° F. As compared to the indicator portion 40 of FIG. 3A, the implementation of one or only a few zones allows the corresponding temperature-sensing device 14 to be of a reduced size, thereby facilitating use with the mouthguard body 12. Regardless, the indicia 62, 52 can assume a wide variety of form, such as numbers, letters, pictures, etc. In fact, the indicia 52, 62 can be eliminated entirely, especially where a single zone is provided.

Returning to FIG. 1, regardless of exact form, the temperature-sensing device 14 is, in one preferred embodiment, secured to the mouthguard body 12 with an adhesive. For example, in one preferred embodiment, the temperature-sensing device 14 is a strip of thermochromic liquid crystal-based material having an adhesive applied to a backside thereof. Prior to assembly to the mouthguard body 12, the adhesive is covered with a paper release liner. During manufacture, the paper release liner is removed from the thermochromic liquid crystal strip. The exposed adhesive is then used to bond the strip 14 to the mouthguard body 12. In this regard, any known medical or dental grade adhesive can be employed. Alternatively, an ultrasonic welding process can be employed to secure the temperature-sensing device 14 to the mouthguard body 12. By preferably providing the recess 30 (FIG. 2) sized to receive the temperature-sensing device 14, upon final assembly, an outer surface of the temperature-sensing device 14 will be substantially contiguous with a corresponding outer or exterior surface of the mouthguard body 12 (such as the exterior surface 32). With this preferred technique, the temperature-sensing device 14 will not substantially protrude relative to the mouthguard body 12 in a manner that might otherwise cause user discomfort. That is to say, while the temperature-sensing device 14, and in particular the indicator portion 40, may extend slightly from a corresponding surface of the mouthguard body 12 (such as the exterior surface 32) due to imperfections and/or contours of that surface, this extension or projection will be minor (i.e., preferably no more than 0.25 inch, more preferably no more than 0.05 inch).

An alternative construction technique entails inserting the temperature-sensing device 14 within the mouthguard body 12 or molding/forming the mouthguard body 12 around the temperature-sensing device 14. For example, FIG. 4 provides a simplified, transverse cross-sectional view of an alternative embodiment athlete body temperature sensing and display device 100 including a mouthguard body 102 and a temperature-sensing device 104. The mouthguard body 102 defines opposing legs 106, 108 having an interior surface 110 and exterior surface 112. One of the legs 106 forms a slot 114 sized to receive and maintain the temperature-sensing device 104 that otherwise includes an indicator portion 116. In the embodiment of FIG. 4, the slot 114 is located proximate the exterior surface 112 of the leg 106 so as to position the temperature-sensing device 104, and in particular the indicator portion 116, in close proximity with the exterior surface 112. With this one design, the indicator portion 116 is readily viewable due to the preferred, relatively transparent nature of the mouthguard body 102 material. Alternatively, the temperature-sensing device 104, and in particular the indicator portion 116, can be located proximate the interior surface 110. Even further during manufacture, the mouthguard body 102 can be molded about the temperature-sensing device 104, thereby eliminating the slot 114.

Returning to FIG. 1 and as previously described, the mouthguard body 12 can be similar to known “stock” mouthguards, “boil and bite” mouthguards, or custom mouthguards. With respect to stock and custom mouthguards, the temperature-sensing device 14 is preferably secured to the mouthguard body 12 prior to supplying the mouthguard 10 to a user. Similarly, the temperature-sensing device 14 can be configured to withstand highly elevated temperatures (e.g., immersed in boiling water), such that the temperature-sensing device 14 can also be pre-applied to a “boil and bite”-type mouthguard body 12. Alternatively, and in one preferred embodiment, the mouthguard body 12 and the temperature-sensing device 14 are supplied to a user separate from one another, preferably as part of a kit. A user then “forms” the mouthguard body 12 pursuant to accepted practices, whereby the mouthguard body 12 is heated (e.g., immersed in boiling water for a predetermined time period). The heated mouthguard body 12 is then inserted into the athlete's mouth where it is subsequently shaped to generally conform with the athlete's mouth and teeth. Once the mouthguard body 12 is sufficiently cooled, the temperature-sensing device 14 is applied thereto, preferably by configuring the temperature-sensing device 14 to include a release liner covering an adhesive backing. In this regard, the preferred recess 30 (FIG. 2) readily directs the user to properly locate and orientate the temperature-sensing device 14.

Regardless of whether the mouthguard 10 is pre-assembled or assembled by a user, the resultant mouthguard 10 is used in a similar fashion. In particular, the athlete places the mouthguard body 12 in his or her mouth, similar to known mouthguards. In this regard and in accordance with one preferred embodiment, the temperature-sensing device 14 is positioned such that upon insertion and final placement of the mouthguard body 12, the temperature-sensing device 14 is in intimate contact with an interior of the athlete's mouth, preferably against the athlete's cheek. The athlete then engages or participates in an athletic activity, with the mouthguard body 12 protecting the user's teeth. Because the mouthguard 10 is entirely within the athlete's mouth, the temperature-sensing device 14 is in constant contact with the athlete's body (and/or in direct contact with the mouthguard body 12 that in turn is in direct contact with the athlete's body), and thus is consistently exposed to the athlete's bodily temperature. Depending upon its particular configuration, the temperature-sensing device 14 thus senses the athlete's bodily temperature and/or senses when the athlete's bodily temperature exceeds one or more predetermined temperatures.

Periodically, or under circumstances by which the athlete or supervisor, coach, trainer, parent, etc. suspects that the athlete's physical exertion has generated an excessively high body temperature, the mouthguard 10 is removed from the athlete's mouth and the indicator portion 40 of the temperature-sensing device 14 visually reviewed. In this regard, the indicator portion 40 provides information indicative of a temperature of the athlete as previously described. Based upon this review, the user, coach, trainer, parent, etc., can determine whether a potentially dangerous body temperature has been reached and take appropriate actions.

Notably, the temperature-sensing device 14 is preferably entirely hidden when the mouthguard 10 is being worn and does not in any way interfere with the athletic performance, such that the user is in no way dissuaded from wearing the mouthguard 10. Because the mouthguard 10 preferably looks similar to available mouthguards that are commonly worn by athletes, an athlete who might otherwise resist wearing something out of the ordinary (such as a child or teenager) will not be adverse to using the temperature sensing and indicating device 10 of the present invention. Thus, the mouthguard 10 is preferably configured such that no portion of the temperature-sensing device 14, including the indicator portion 40, extends or protrudes from the athlete's mouth when the mouthguard body 12 is being worn. An entirety of the temperature-sensing device 14 is preferably rigidly secured to the mouthguard body 12, such that the temperature-sensing device 14 cannot be moved independent of the mouthguard body 12 in a manner that could otherwise damage the temperature-sensing device 14, including the indicator portion 40. Further, the preferred configuration of the temperature-sensing device 14 as a thermometric strip is such that the temperature-sensing device 14 will remain fully operational when the mouthguard 10 is subjected to various jarring or impact forces that inevitably occur during an athletic activity. This one preferred configuration does not include any sensitive electronic components or require a separate power supply, either of which could fail when impacted, even by the athlete biting down on the mouthguard body 12. Similarly, preferred bonding of the temperature-sensing device 14 to the mouthguard body 12 will not fail under similar circumstances.

The temperature sensing and indicating device/mouthguard of the present invention provides a marked improvement over previous designs. In particular, by providing the mouthguard with a temperature-sensing device that does not impede performance, users will be highly encouraged to wear the mouthguard of the present invention while providing ready access to information indicative of their body temperature. Known athletic mouthguards do not provide any temperature sensing or indicating functions. Conversely, available temperature-sensing device are simply not viable for athletic applications. The present invention overcomes these deficiencies in a simple yet highly effective manner.

Although the present invention has been described with reference to preferred embodiments, worker's skilled in the art will recognize that changes can be made in form and detail without departing from the spirit and scope of the present invention.

What is claimed is:

1. A device for sensing and displaying body temperature information of an athlete participating in an athletic activity, the device comprising:
a generally U-shaped mouthguard body sized for placement over a substantial portion of at least some of the athlete's teeth and configured to protect a user's teeth during athletic activities; and
a temperature-sensing device maintained by the mouthguard body and including an indicator portion adapted to visually indicate information indicative of temperature;
wherein the temperature-sensing device is positioned such that upon placement of the mouthguard body within a athlete's mouth, the temperature-sensing device is also within the athlete's mouth, and further wherein the temperature-sensing device is adapted such that functioning thereof is unaffected by jarring of the mouthguard body when the user participates in an athletic activity.

2. The device of claim 1, wherein an entirety of the temperature-sensing device is rigidly to the mouthguard body.

3. The device of claim 1, wherein the temperature-sensing device is adapted such that the indicator portion does not substantially project beyond a corresponding surface of the mouthguard body.

4. The device of claim 1, wherein the temperature-sensing device is adapted such that the mouthguard body must be removed from the user's mouth to view the indicator portion.

5. The device of claim 1, wherein the mouthguard body defines a baccal wall, the temperature-sensing device being maintained at the baccal wall.

6. The device of claim 1, wherein the mouthguard body is defined by a base, an inner wall, and an outer wall that combine to define a central region, otherwise adapted for placement over incisor teeth, and two opposing legs extending from the central region, the temperature-sensing device being maintained by the outer wall along one of the opposing legs.

7. The device of claim 1, wherein the mouthguard body includes an exterior surface defining a recess, the temperature-sensing device being secured within the recess.

8. The device of claim 1, wherein the temperature-sensing device is bonded to an exterior surface of the mouthguard body with an adhesive.

9. The device of claim 1, wherein the temperature-sensing device is entirely disposed within the mouthguard body.

10. The device of claim 1, wherein the mouthguard body is adapted for placement at an upper jaw of the user.

11. The device of claim 1, wherein the temperature-sensing device includes thermochromic liquid crystals.

12. The device of claim 1, wherein the temperature-sensing device is adapted to sense a predetermined temperature, and further wherein the indicator portion is adapted to visually indicate sensing of the predetermined temperature.

13. The device of claim 12, wherein the temperature-sensing device is adapted to sense a plurality of predetermined temperatures, and further wherein, the indicator portion includes a plurality of discrete display zones corresponding with each of the plurality of predetermined temperatures, the discrete display zones visually indicating sensing of the corresponding predetermined temperature.

14. A method of manufacturing a mouthguard for use by an athlete in conjunction with an athletic activity, the method comprising:
providing a generally U-shaped mouthguard body sized for placement over a substantial portion of at least some of a user's teeth;
providing a temperature-sensing device including an indicator portion adapted to visual indicate information indicative of temperature; and
securing the temperature-sensing device to the mouthguard body such that the temperature-sensing device will be positioned within a user's mouth when the mouthguard body is worn;
wherein securement and functioning of the temperature-sensing device is unaffected by jarring of the mouthguard body when worn by a user participating in an athletic activity.

15. The method of claim 14, wherein securing the temperature-sensing device includes bonding the temperature-sensing device to the mouthguard body with an adhesive.

16. The method of claim 15, wherein the mouthguard body is defined by a base, an inner wall, and an outer wall that combine to define a central region, otherwise adapted for placement over incisor teeth, and two opposing legs extending therefrom, and further wherein bonding the temperature-sensing device includes securing the temperature-sensing device to an exterior surface of the outer wall along one of the opposing legs.

17. The method of claim 14, wherein following securing of the temperature-sensing device, the indicator portion is not movable relative to the mouthguard body.

18. The method of claim 14, further comprising:
(a) heating the mouthguard body to an elevated temperature prior to applying the temperature-sensing device; and
(b) shaping the mouthguard body in accordance with the user's teeth by placing the heated mouthguard body in the user's mouth;
wherein the temperature-sensing device is secured to the mouthguard body after step b).

19. The method of claim 14, wherein securing the temperature-sensing device includes positioning the temperature-sensing device within the mouthguard body.

20. A method sensing and displaying a temperature-related information of an athlete participating in an athletic activity, the method comprising:
(a) providing a mouthguard including a generally U-shaped mouthguard body and a temperature-sensing device maintained by the mouthguard body, the temperature-sensing device including an indicator portion adapted to visually indicate information indicative of temperature;
(b) placing the mouthguard in an athlete's mouth, wherein the temperature-sensing device is within an interior of the athlete's mouth;
(c) participating in an athletic activity with the mouthguard in place;
(d) removing the mouthguard from the athlete's mouth to expose the indicator portion; and
(e) determining whether a temperature of the athlete is above an acceptable level by viewing the indicator portion.

21. The method of claim 20, wherein step a) includes providing the mouthguard body and the temperature-sensing device as separate components, step a) further comprising:
heating the mouthguard body to an elevated temperature;
shaping the mouthguard body in accordance with the athlete's teeth by placing the heated mouthguard body in the athlete's mouth; and
applying the temperature-sensing device to the mouthguard body after shaping the mouthguard body.
